(19) United States
(12) Patent Application Publication
(10) Pub. No.: US 2007/0118778 A1
(43) Pub. Date: May 24, 2007

(54) Method and/or apparatus to detect and handle defects in a memory

(75) Inventor: Linley M. Young, San Diego, CA (US)

Correspondence Address: CHRISTOPHER P. MAIORANA, P.C., 24840 HARPER SUITE 100, ST. CLAIR SHORES, MI, 48080, US

(73) Assignee: VIA TELECOM CO., LTD.

(21) Appl. No.: 11/377,875

(22) Filed: Mar. 16, 2006

Related U.S. Application Data
(60) Provisional application No. 60/736,067, filed on Nov. 10, 2005.

(51) Int. Cl. G06F 11/00

(52) U.S. Cl. 714/100

(57) ABSTRACT

An apparatus comprising a memory circuit, a test circuit, an interface circuit and a defect handler circuit. The memory circuit may be configured to store and retrieve data in response to (i) a data signal, (ii) a test data signal, (iii) an address signal, (iv) a first control signal and (v) a write signal. The test circuit may be configured to generate the test data signal in response to the address signal. The interface circuit may be configured to generate the control signal in response to (i) the address signal, (ii) a read signal, and (iii) the write signal. The defect handler circuit may be configured to redirect data read from the memory circuit in response to (i) the address signal, (ii) the data signal and (iii) the write signal.

This application claims the benefit of U.S. Provisional Application No. 60/736,067, filed Nov. 10, 2005 and is hereby incorporated by reference in its entirety.

### FIELD OF THE INVENTION

The present invention relates to defect detection circuits generally and, more particularly, to a method and/or apparatus to detect and handle defects in a memory.

### BACKGROUND OF THE INVENTION

Many conventional chip designs are implemented as system on a chip (SOC) designs, which include one or more processors and several memories in the processor memory subsystem. The memories can include random access memory (RAM) to store data or read only memory (ROM) to store program code. Often the memory in a processor uses a significant percentage of the total die area.

Due to high layout density, RAMs typically have higher defect density than standard logic cells. The defects are introduced during the manufacturing process of the chip. A high defect density reduces the overall yield of functional dies and hence increases the cost of manufacturing.

In order to detect defects in a RAM, memory built-in self-test (BIST) logic is typically inserted into a design so that the memory can be tested during wafer sort using BIST test vectors. Defects such as stuck-at, transition, and coupling can be detected. If the BIST test fails, the die is discarded and the yield of good dies is reduced. Only the remaining dies go into production.

Another conventional approach is sometimes used to improve the yield loss due to RAM defects. Such an approach involves the use of repairable memories which include extra storage locations that may be substituted for the defective bit locations. Repairable memories may need to be designed if they are not already available in a certain manufacturing process. They may need to be purchased from a third party vendor for use in a chip, and there may be added royalty costs for each chip sold. When a defect is detected, such as through BIST testing, an additional manufacturing step occurs in order to replace defective bit locations with the redundant memory bits. An on-chip fuse box can be programmed one time using a laser, or on-chip non-volatile memory can be programmed multiple times to configure the repair. This step also adds additional cost.

It would be desirable to implement a method and/or apparatus to detect and/or handle defects in a memory without one or more of the disadvantages of conventional approaches.

### SUMMARY OF THE INVENTION

The present invention concerns an apparatus comprising a memory circuit, a test circuit, an interface circuit and a defect handler circuit. The memory circuit may be configured to store and retrieve data in response to (i) a data signal, (ii) a test data signal, (iii) an address signal, (iv) a first control signal and (v) a write signal. The test circuit may be configured to generate the test data signal in response to the address signal. The interface circuit may be configured to generate the control signal in response to (i) the address signal, (ii) a read signal, and (iii) the write signal. The defect handler circuit may be configured to redirect data read from the memory circuit in response to (i) the address signal, (ii) the data signal and (iii) the write signal.

The objects, features and advantages of the present invention include providing a method and/or apparatus that may (i) detect and handle defects in a memory, (ii) be implemented without laser fuses or other additional processing steps and/or (iii) be implemented in hardware separately from a processor.

### BRIEF DESCRIPTION OF THE DRAWINGS

These and other objects, features and advantages of the present invention will be apparent from the following detailed description and the appended claims and drawings in which:

FIG. 1 is a block diagram of the present invention;

FIG. 2 is a more detailed diagram of the present invention;

FIG. 3 is a timing diagram of the present invention; and

FIG. 4 is a flow diagram illustrating an example of a state machine of the present invention.

### DETAILED DESCRIPTION OF THE PREFERRED EMBODIMENTS

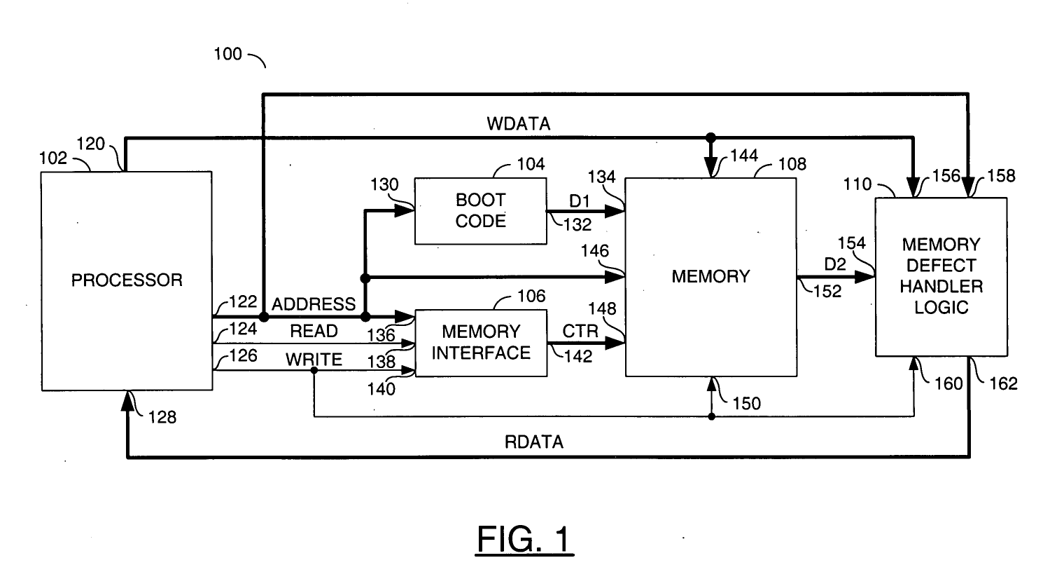

Referring to FIG. 1, a block diagram of a circuit 100 is shown in accordance with a preferred embodiment of the present invention. The circuit 100 generally comprises a block (or circuit) 102, a block (or circuit) 104, a block (or circuit) 106, a block (or circuit) 108 and a block (or circuit) 110. The circuit 102 may be implemented as a processor, such as a microprocessor, a microcontroller, or a digital signal processor (DSP). The circuit 104 may be implemented as a boot code block. The circuit 106 may be implemented as a memory interface circuit. The circuit 108 may be implemented as a memory. In one example, the memory 108 may be a random access memory (RAM). The circuit 110 may be implemented as a memory defect handler logic circuit. The processor 102 may have an output 120 that may present a signal (e.g., WDATA), an output 122 that may present a signal (e.g., ADDRESS), an output 124 that may present a signal (e.g., READ), an output 126 that may present a signal (e.g., WRITE) and an input 128 that may receive a signal (e.g., RDATA). The signal WDATA, the signal ADDRESS and the signal RDATA may be implemented as multi-bit signals. The signal READ may be a read control signal. The signal WRITE may be a write control signal. The signal READ and the signal WRITE may be either single bit or multi-bit control signals.

The boot code circuit 104 may have an input 130 that may receive the signal ADDRESS. The circuit 104 may have an output 132 that may present a signal (e.g., D1) to an input 134 of the memory 108. The signal D1 may be a test data signal transmitted on a data bus. The signal D1 may be multiplexed within the memory 108 along with other memory signals. The circuit 106 may have an input 136 that may receive the signal ADDRESS, an input 138 that may receive the signal READ, an input 140 that may receive the signal WRITE and an output 142 that may present a signal (e.g., CTR). The signal CTR may be a control signal. The memory 108 may also have an input 144 that may receive the signal WDATA, an input 146 that may receive the signal ADDRESS, an input 148 that may receive the signal CTR, an input 150 that may receive the signal WRITE and an output 152 that may present a signal (e.g., D2). The memory defect handler logic 110 may have an input 154 that may receive the signal D2, an input 156 that may receive the signal WDATA, an input 158 that may receive the signal ADDRESS, an input 160 that may receive the signal WRITE and an output 162 that may present the signal RDATA.

The system 100 may be implemented as a system on a chip design. The memory 108 may be implemented as a memory subsystem. The memory subsystem 108 may be implemented as one or more RAM and/or ROM memories for program code and/or data storage. The processor 102 may read from the ROM memories and/or read from and write to the RAM memories. The memory 108 may include built-in self test (BIST) logic inserted around the memories within memory 108 in order to allow detection of defects, typically during the wafer sort stage of manufacturing. BIST testing may be used to determine which particular memory circuits within the memory 108 are failing. The BIST testing may also be used to determine the type of failures within the memory 108.

The system 100 may be used to handle memory defects by including the boot code block 104. The boot code block 104 may be used to implement a fixed set of instructions that the processor 102 executes upon chip power up. The boot code 104 may reside in ROM, may be synthesized as standard cell logic, or may be otherwise implemented. The system 100 also includes redundant storage space in the memory defect handler circuit 110, as well as logic to substitute the redundant storage space for the defective bits. The substitution may be at the cell level or the block level or may involve substituting an entire row of cells. The logic is stored in the memory defect handler 110. On power up, the processor 102 may execute a memory test which is part of the boot code program 104. The boot code program 104 normally involves writing a test pattern into a RAM location, then reading out the test pattern to detect failures such as stuck-at, transition, or coupling faults. For example, the processor 102 can write “1010 . . . ” into a memory location and read the same pattern back from the memory 108. The processor 102 may then write the inverse pattern “0101 . . . ” into same memory location and then read back “0101 . . . ”. If the processor 102 does not read the correct pattern from the memory 108, the processor 102 programs the memory defect handler 110 with the memory address location that failed. More complex memory tests may be used in the boot code 104 to meet the design criteria of a particular implementation. However, the more complex the test, the more boot code space and/or memory test time may be needed at power up.

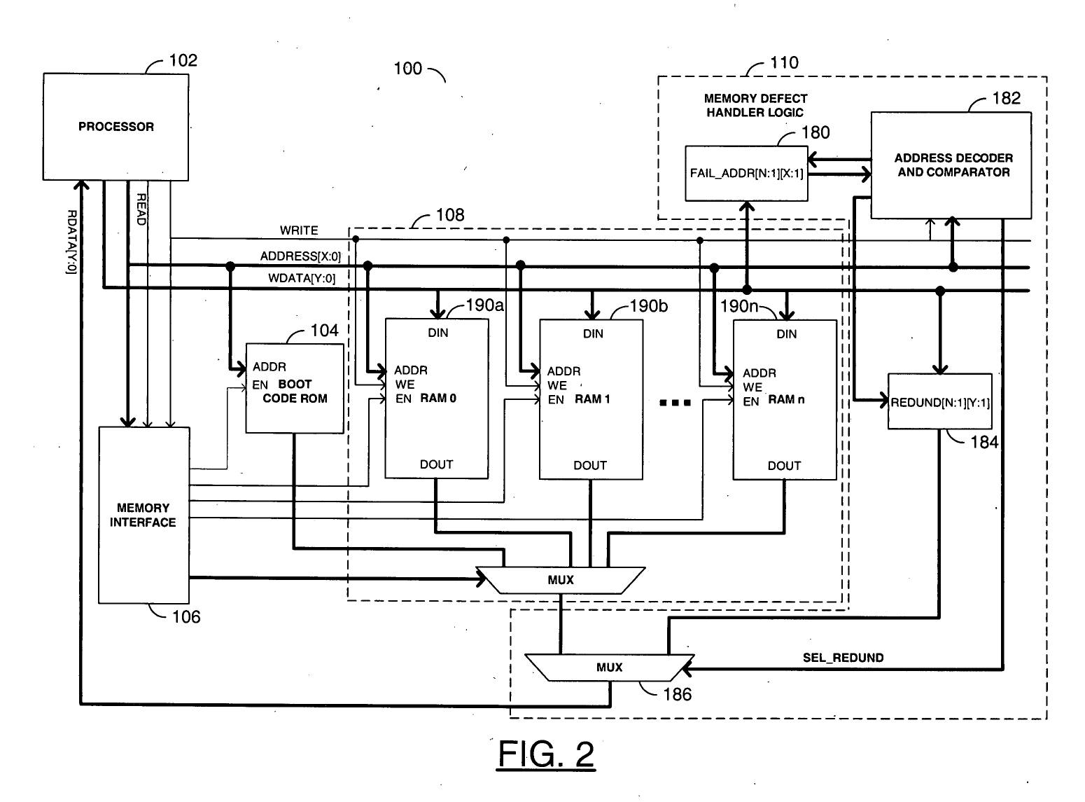

Referring to FIG. 2, a more detailed diagram of the system 100 is shown. The memory defect handler 110 generally comprises a block (or circuit) 180, a block (or circuit) 182, a block (or circuit) 184 and a block (or circuit) 186. The block 180 may be a address failure circuit. The block 182 may be implemented as an address decoder and comparator circuit. The block 184 may be implemented as a redundant memory cell circuit. The block 186 may be implemented as a select circuit. The memory 108 generally comprises a number of memory blocks 190a-190n. Each of the memory blocks 190a-190n generally comprises one or more memory cells. The particular number of cells in each of the memory blocks 190a-190n may be varied to meet the design criteria of a particular implementation.

The circuit 180 may include a bank of N X-bit wide registers configured to store the failing memory address locations (e.g., FAIL_ADDR [N:1] [X:1]. The circuit 184 may be implemented as N Y-bit wide registers that may implement redundant storage locations (e.g., REDUND[N:1] [Y:1]. In general, for each address register in the circuit 180, there is a corresponding redundant storage register in the circuit 184. The value ‘N’ may be an integer determined for a particular implementation by the predicted amount of failing memory locations. Typically, the number of failing memory locations may be estimated by the RAM area and a known RAM defect density which is provided by the manufacturer. The parameter ‘X’ may be set to match the address bus width of the processor 102. The parameter ‘Y’ is normally the width of the memory data bus (e.g., the signals WDATA and RDATA), typically the data bus width of the processor 102. The redundant storage circuit 184 may be flexibly assigned to any address within the memory subsystem of the processor 102. In general, any of the memory cells in the memory circuit 108 may be repaired. A chip designer does not need to decide at the design stage which memory are repairable, since all of the cells are repairable.

When the processor 102 detects a failing RAM address location, the processor 102 programs one of the N address registers with the failing memory address. Writing to a failed address register may automatically set an enable bit which enables the defect handling mechanism for the particular failed address location. Alternatively, the processor 102 may be able to set the enable bit. Each failed address register has a corresponding enable bit. If defect handling is enabled for a particular address, then whenever the processor address bus matches any one of the programmed failing addresses, the corresponding redundant register is accessed instead. For example, if the processor 102 writes to a failed (or failing) address location, data is written into the redundant storage. Data may also simultaneously be written into the failed address location if the memory 108 is not blocked. Alternately, the memory 108 may be blocked when the failing address is accessed. Blocking failed address locations may reduce the power consumption of the memory 108. When the processor 102 reads from a failed address location, the memory defect handler 110 may multiplex data from the corresponding redundant storage register onto the signal RDATA (through a readback bus) instead of from the failing memory.

Since typical memory defects are single-bit failures rather than an entire Y-bit location, other variants of the defect handler 110 may be implemented. For example, instead of a Y-bit wide register which replacing the failing memory location, a 1-bit register may be used to replace the failing memory bit. In such an implementation, a bank of N Z-bit registers may be implemented in order to store the failing bit location, where Z is the number of bits needed to encode the failing bit location. A balance between overall area savings may be achieved.

BIST testing is normally still performed to determine how many memory locations are failing and the type of failures. If a certain type of failure is not detectable by the memory test of the processor 102, then the particular tested die is normally discarded if the die fails during BIST testing for that type of failure. If more than N memory locations are failing, then the defect handler 110 may not have enough registers to handle all of the failures, and therefore the die may be also be discarded. In general, the system 100 allows dies with less than or equal to N failures to go into production.

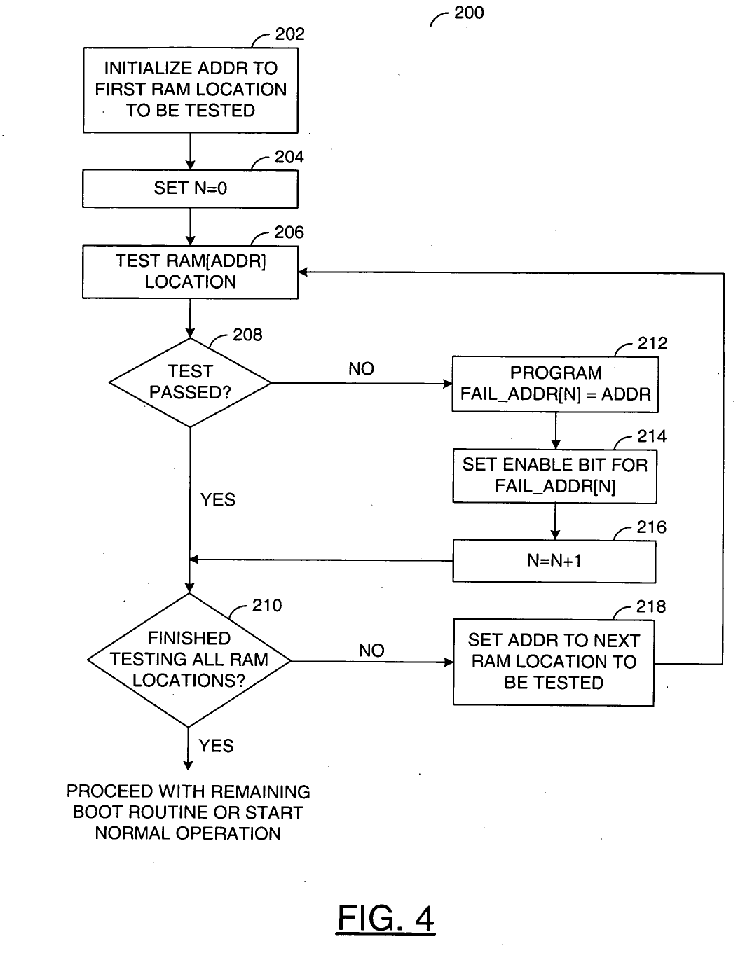

Rather than involving the DSP 102, the RAM defect handler circuit 110 may be implemented entirely in hardware. Such a hardware implementation may reduce the time to detect the faults compared to a DSP solution. For example, hardware may be added to control reads and writes of the memory 108. A simple state machine (to be described in more detail in connection with FIG. 4) may be used to write a known pattern into the RAM memory space, read from the memory 108, and compare the output to the expected data. Such a state machine may sequence through all RAM address locations. If a failure occurs, the failing address is automatically captured into the bank of failing address registers and defect handling is enabled for the failing register. After the hardware is finished checking the RAMs, the RAM default handler 110 signals to the DSP 102 that the memories 108 are ready to be used.

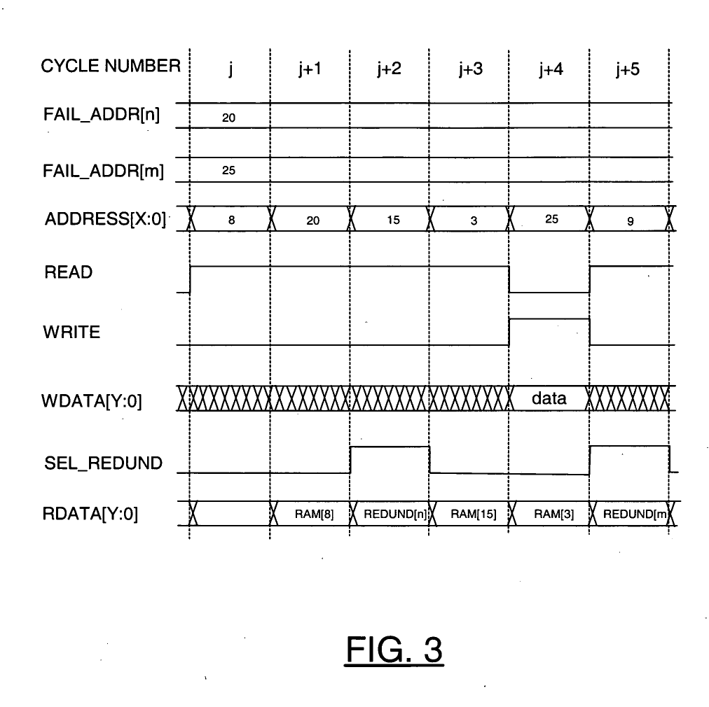

Referring to FIG. 3, a timing diagram of the present invention is shown. The timing diagram illustrates an example of the processor addresses and data busses during accesses to the memory 108. In the example shown, the processor 102 has already determined that memory location 20 is bad and has programmed an address (e.g., FAIL_ADDR[n]) to be associated with the memory location 20. The processor 102 has also determined that a memory location 25 is bad and has programmed an address (e.g., FAIL_ADDR[m]) associated with the memory location 25. A number of clock cycles j through j+5 are shown. In the cycles j through j+3, the processor 102 reads from the memory 108. In the cycle j, the address bus pointing to an address (e.g., ADDRESS[X:0]) does not match any of the addresses FAIL_ADDR[N:1]. Data from the memory 108 is presented on the read data bus (RDATA[Y:0]) as normal in the cycle j.

In the cycle j+1, the address ADDRESS[X:0] matches the address FAIL_ADDR[n]. Data from an address REDUND[n] (instead of from the address RAM[20]) is presented on the read data bus RDATA[Y:0] in cycle j+2. A signal (e.g., SEL_REDUND) may be a multiplexer select signal configured to control the multiplexer 186 (of FIG. 2). When the signal SEL_REDUND is high, the redundant memory (REDUND[N:1] [Y:1]) is selected for readback on the read data bus RDATA[Y:0]. In the cycle j+4, the processor 102 writes to the memory 108. Since the ADDRESS[X:0] matches the address FAIL_ADDR[m], data on the write data bus WDATA[Y:0] may be written into the redundant memory 184 (e.g., at a location REDUND[m]) instead of to the memory 108 (e.g., at a location RAM[25]). The data from the location REDUND[m] may then be presented onto the read data bus RDATA in the cycle j+5.

Referring to FIG. 4, an example of a state machine (e.g., a method or process) 200 in accordance with the present invention is shown. The state machine 200 generally comprises a step (or state) 202, a step (or state) 204, a step (or state) 206, a decision step (or state) 208, a decision step (or state) 210, a step (or state) 212, a step (or state) 214, a step (or state) 216 and a step (or state) 218. The state 202 may initialize the signal ADDR (or ADDRESS) to point to a first memory location of the memory 108 to be tested. Next, the state 204 sets a variable (e.g., N) equal to zero. Next, the state 206 tests the memory cells at the location ADDR. Next, the state 208 determines if the tested location passed the test. If so, the process 200 moves to the decision state 210. The decision state 210 determines if all of the memory locations have been tested. If so, a process 200 proceeds to another process that may provide a boot routine or a start routine. If the state 208 determines that the particular location does not pass, the method 200 moves to the state 212. The state 212 programs a failed address register to store the memory location ADDR. Next, the state 214 sets an enable bit for the failed address register. Next, the state 216 increments the variable n to be equal to n+1. If the decision state 210 determines that all the memory locations have not been tested, the method 200 moves to the state 218. The state 218 sets the signal ADDR to the next memory location to be tested and then moves back to the state 206.

While the invention has been particularly shown and described with reference to the preferred embodiments thereof, it will be understood by those skilled in the art that various changes in form and details may be made without departing from the spirit and scope of the invention.

1. An apparatus comprising:
a memory circuit configured to store and retrieve data in response to (i) a data signal, (ii) a test data signal, (iii) an address signal, (iv) a control signal and (v) a write signal;
a test circuit configured to generate said test data signal in response to said address signal;
an interface circuit configured to generate said control signal in response to (i) said address signal, (ii) a read signal, and (iii) said write signal; and
a defect handler circuit configured to redirect data read from said memory circuit in response to (i) said address signal, (ii) said data signal and (iii) said write signal.

2. The apparatus according to claim 1, further comprising:
a processor configured to (i) read and write data to said defect handler circuit and (ii) generate said address signal, said read signal and said write signal.

3. The apparatus according to claim 1, wherein said memory comprises a plurality of random access memory circuits.

4. The apparatus according to claim 2, wherein said test circuit generates said control signal during a boot sequence.

5. The apparatus according to claim 3, wherein each of said random access memory circuits comprises a plurality of memory cells.

6. The apparatus according to claim 5, wherein said defect handler circuit comprises a plurality of redundant memory cells configured to replace one or more of said memory cells having defects.

7. The apparatus according to claim 6, wherein said defect handler circuit comprising:
an address circuit configured to store said memory cells having defects;
a decoder and compare circuit configured to compare with said address signal and said-address circuit;
a redundant cell circuit comprising said plurality of redundant memory cells; and
a multiplexer circuit configured to select the redirected data read from said memory circuit.

8. The apparatus according to claim 6, wherein said defect handler circuit replaces a row of memory cells in response to a defect.

9. A method for detecting and disabling defective memory cells in a memory, comprising the steps of:
(A) executing a fixed set of instructions for testing each of a number of primary cells of said memory;
(B) creating a list of addresses corresponding to a number of failed primary cells; and
(C) enabling a secondary cell for each of said failed primary cells.

10. The method according to claim 9, wherein said method is executed during a boot sequence of a processor that reads and writes data to said memory.

11. The method according to claim 9, wherein step (A) comprises enabling a row of secondary cells for a row of cells containing said failed primary cells.

12. The method according to claim 9, further comprising:
writing data to said secondary cells during a write operation of writing to said failed primary cells.

13. The method according to claim 9, further comprising:
reading data from said secondary cells during a read operation of reading from said failed primary cells.
